(19) United States
(12) Patent Application Publication
(10) Pub. No.: US 2023/0292918 A1
(43) Pub. Date: Sep. 21, 2023

(54) UNDER STRUCTURE STORAGE

(71) Applicant: Pamela Castaneda-Moretz, Louisville, KY (US)

(72) Inventor: Pamela Castaneda-Moretz, Louisville, KY (US)

(21) Appl. No.: 17/698,966

(22) Filed: Mar. 18, 2022

(51) Int. Cl. A47B 88/40; E04B 1/00; B62H 3/00

(52) U.S. Cl. CPC A47B 88/40; B62H 3/00; E04B 1/0007

(57) ABSTRACT

An under-structure storage device for storing items is presented. The under-structure storage device is coupled to an underside of a structure such as a crawl space under the structure. The device is suitable for structures such as a house, a mobile home, a trailer, an eighteen-wheeler box truck storage unit, camper, tent structures etc. Furthermore, the device provides easy access, protection against damage, contamination and/or theft of contents stored in the device. The device has one or more enclosures and one or more drawers where the drawers may be inserted into the enclosures.

### FIELD OF THE INVENTION

This invention relates to storage areas. More particularly, it relates to a under structure storage that can be used in multiple locations and structures.

### BACKGROUND

A drawer is a box-shaped container inside a piece of furniture or equipment that can be pulled out horizontally to access its contents.

Drawers can be built in various ways using a variety of materials, including wood, various wood composites, sheet metal, and plastic. Drawers are built into numerous types of furniture or equipment, including cabinets, chests of drawers (bureaus), desks, vehicles, trailers, and the like. Drawers typically do not have drawer enclosures protecting them.

According, and in light of the foregoing, it would be desirable to have one or more drawers attached under a structure for use of storage. The drawers may have drawer enclosures for easy accessibility as well as to protect from damage, contamination, and/or theft. The structure where the drawers are attached may be a tiny house, a mobile home, a trailer, an eighteen-wheeler box truck/storage unit, a camper and tent/storage equipment, a porch, stairs, deck, or a shed.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an in-use view of under structure storage 100, according to an embodiment of the present invention;

FIG. 2 is a front isometric view of under structure storage 100, according to an embodiment of the present invention, illustrating an individual storage drawer 202;

FIG. 3 is a front isometric view of under structure storage 100, according to an embodiment of the present invention, illustrating an individual enclosure 232;

FIG. 4 is a rear isometric view of under structure storage 100, according to an embodiment of the present invention, illustrating an individual storage drawer 202;

FIG. 5 is a front isometric view of under structure storage 100, according to an embodiment of the present invention, illustrating a ventilated storage drawer 202 and a ventilated enclosure 232;

FIG. 6 is a front isometric view of under structure storage 100, according to an embodiment of the present invention, illustrating an individual storage drawer 202 and an individual enclosure 232 comprising a drawer opener; and,

FIG. 7 is a rear isometric view of under structure storage 100, according to an embodiment of the present invention, illustrating an individual enclosure 232 comprising a drawer opener.

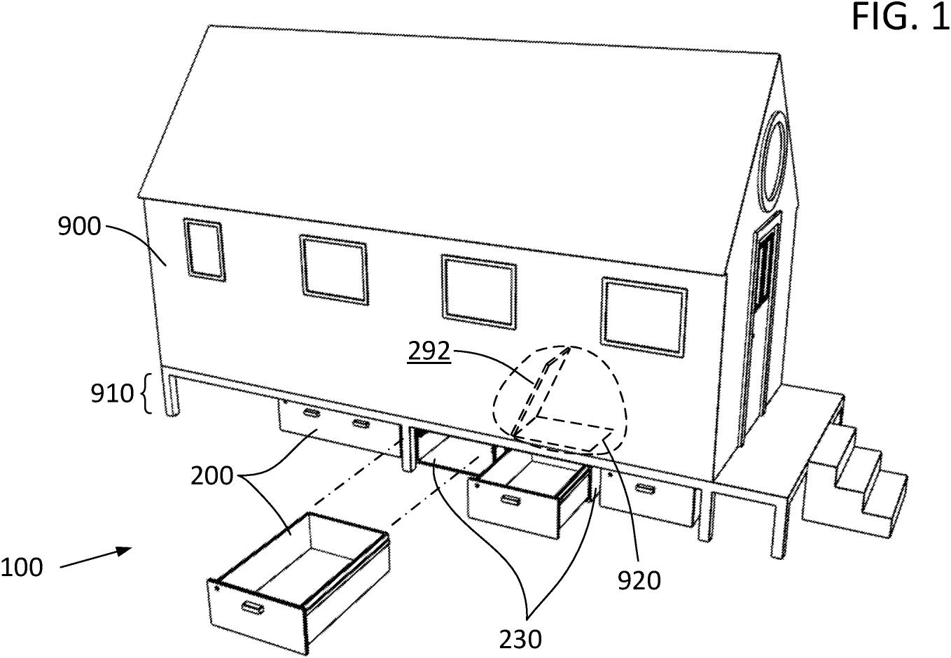

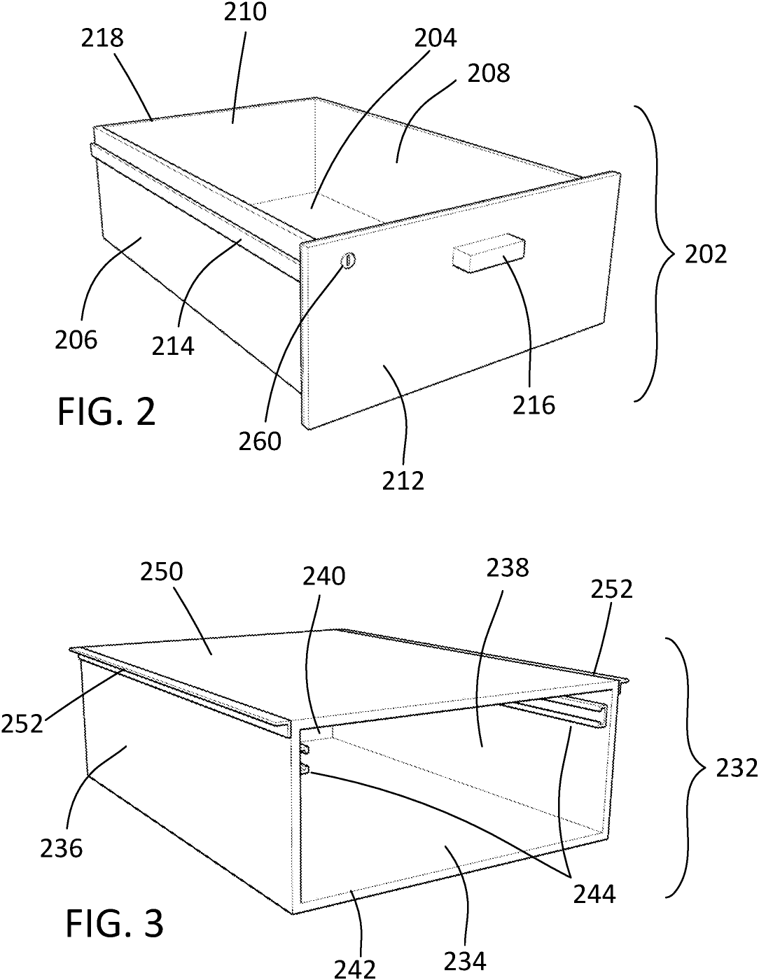

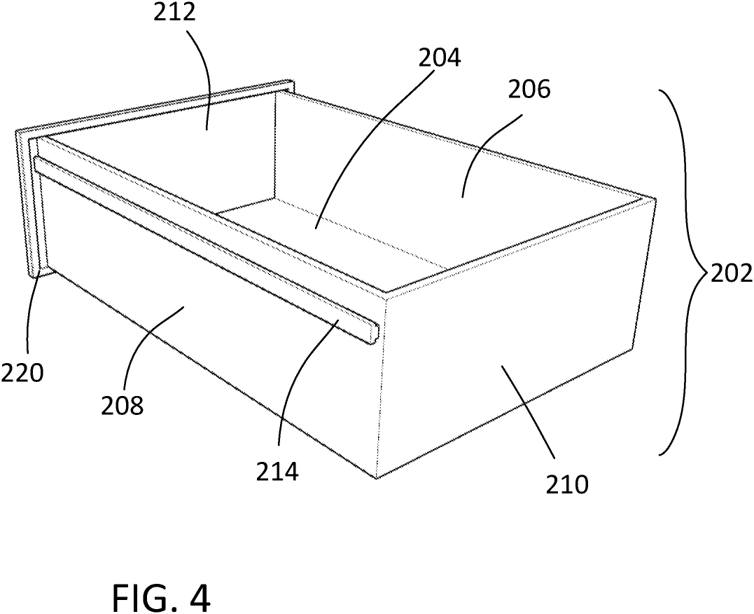

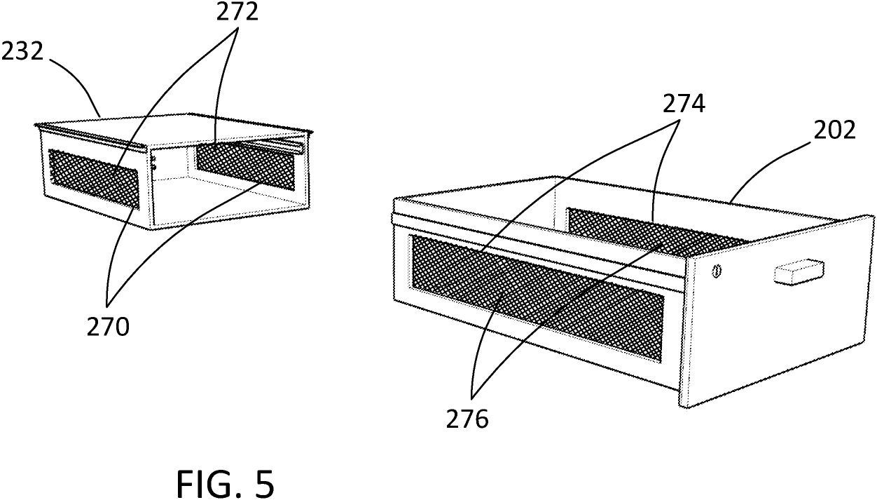

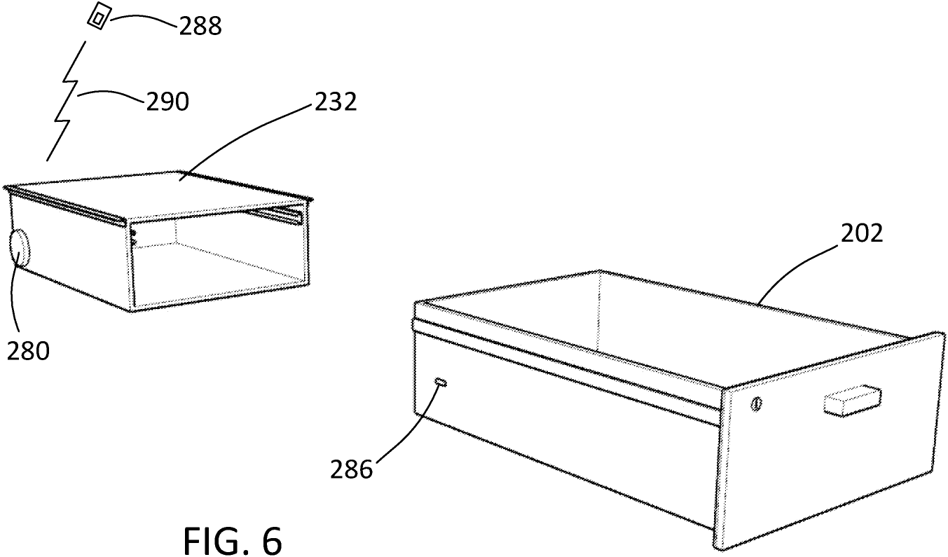

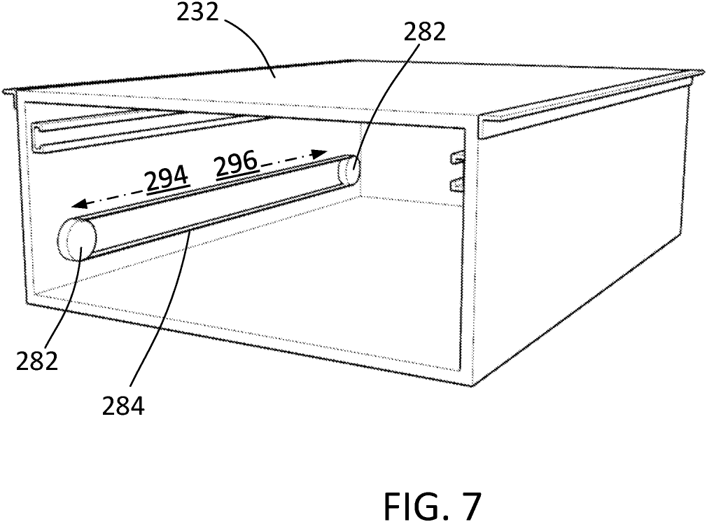

DESCRIPTIVE KEY

| | |
|---|---|
| 100 | under structure storage |
| 200 | storage drawer |
| 202 | individual storage drawer |
| 204 | drawer bottom |
| 206 | drawer left side wall |
| 208 | drawer right side wall |
| 210 | drawer rear wall |
| 212 | drawer front |
| 214 | drawer rail |
| 216 | handle |
| 218 | drawer top aperture |
| 220 | gasket |
| 230 | drawer enclosure |
| 232 | individual enclosure |
| 234 | enclosure bottom |
| 236 | enclosure left side wall |
| 238 | enclosure right side wall |
| 240 | enclosure rear wall |
| 242 | enclosure front aperture |
| 244 | enclosure rail |
| 250 | enclosure top |
| 252 | enclosure mount |
| 260 | lock |
| 270 | enclosure vent aperture |
| 272 | enclosure vent screen |
| 274 | drawer vent aperture |
| 276 | drawer vent screen |
| 280 | motor |
| 282 | pulley |
| 284 | belt |
| 286 | drawer belt interface |
| 288 | remote control |
| 290 | wireless signal |
| 292 | trap door |
| 294 | first direction |
| 296 | second direction |
| 900 | structure |
| 910 | crawl space |
| 920 | floor aperture |

### DESCRIPTION OF THE INVENTION

The present invention is directed to under structure storage (herein described as the “invention”) 100. The invention 100 may comprise one (1) or more storage drawers 200 and one (1) or more drawer enclosures 230. The one (1) or more storage drawers 200 may reside within the one (1) or more drawer enclosures 230 such that contents of the one (1) or more storage drawers 200 are protected from damage, easy access, contamination, and/or theft. The one (1) or more drawer enclosures 230 may be coupled to an underside of a structure 900 such that a crawl space 910 under the structure 900 may be used for storage. As non-limiting examples, the structure 900 may be a tiny house, a mobile home, a trailer, eighteen-wheeler box truck storage unit, a camper, tent/storage equipment, a porch, stairs, deck, or a shed. The one (1) or more storage drawers 200 may be over-sized in comparison to a traditional desk drawer, dresser drawer, or kitchen cabinet drawer. As a non-limiting example, an individual storage drawer 202 selected from the one (1) or more storage drawers 200 may be operable to hold a bicycle. When more than one (1) of the individual storage drawers 202 are installed on the same structure, the individual storage drawers 202 may be of homogeneous or heterogeneous sizes.

The individual storage drawer 202 may comprise a drawer bottom 204, a drawer left side wall 206, a drawer right side wall 208, a drawer rear wall 210, and a drawer front 212. The individual storage drawer 202 may be the shape of a rectangular prism. The top of the individual storage drawer 202 may comprise a drawer top aperture 218 such that the contents may be accessed. In some embodiments, the drawer front 212 may extend beyond the dimensions of an enclosure front aperture 242. A gasket 220 coupled to the inside edges of the drawer front 212 may be pressed between the drawer front 212 and an individual enclosure 232 selected from the one (1) or more drawer enclosures 230 such that the gasket 220 seals the individual storage drawer 202 and the individual enclosure 232 from moisture and dirt.

As non-limiting examples, the individual storage drawer 202 may be made from metal, plastic, or wood. If the individual storage drawer 202 is made from wood, all or part of the wood may be a natural insect repellent. As a non-limiting example, at least part of the individual storage drawer 202 may be made from cedar or a durable substance.

The individual storage drawer 202 may comprise a pair of drawer rails 214. The pair of drawer rails 214 may be coupled to the outside of the drawer left side wall 206 and the drawer right side wall 208. The pair of drawer rails 214 may extend horizontally in a front-to-rear direction.

In some embodiments, the individual storage drawer 202 may comprise a handle 216. As non-limiting examples, the handle 216 may project forward from the front of the drawer front 212 or the handle 216 may be recessed into the drawer front 212. In some embodiments where a user may desire to disguise the presence of the individual storage drawer 202, the handle 216 may be moved to the lower rear edge of the drawer front 212 such that the user may reach around behind the bottom of the drawer front 212 to pull the individual storage drawer 202.

The one (1) or more drawer enclosures 230 may be coupled to the underside of the structure 900 such that the fronts of the one (1) or more storage drawers 200 residing in the one (1) or more drawer enclosures 230 align with a side of the structure 900 to which the individual storage drawers 202 are coupled. The one (1) or more drawer enclosures 230 may be coupled to provide the one (1) or more storage drawers 200 along any side of the structure 900 that is free of obstacles. As non-limiting examples, obstacles may comprise foundational supports, piers, undercarriage, and plumbing, water, sewer and/or gas service connections.

The individual enclosure 232 may comprise an enclosure bottom 234, an enclosure left side wall 236, an enclosure right side wall 238, and an enclosure rear wall 240. The individual enclosure 232 may be the shape of a rectangular prism. The front of the individual storage drawer 202 may comprise the enclosure front aperture 242 such that the individual storage drawer 202 may be moved into and out of the individual enclosure 232.

The individual enclosure 232 may comprise a pair of enclosure rails 244. The pair of enclosure rails 244 may be coupled to the inside of the enclosure left side wall 236 and the enclosure right side wall 238. The pair of enclosure rails 244 may extend horizontally in a front-to-rear direction. The pair of enclosure rails 244 may be positioned vertically such that the pair of drawer rails 214 on the individual storage drawer 202 may movably couple with the pair of enclosure rails 244 on the individual enclosure 232. The individual storage drawer 202 may be adapted to be moved in and out of the individual enclosure 232 as the pair of drawer rails 214 travel on top of the pair of enclosure rails 244. As non-limiting examples, the pair of drawer rails 214 and the pair of enclosure rails 244 may utilize sliding surfaces, ball bearings, rollers, other drawer rail technologies such as a remote control device, or combinations thereof.

The dimensions of the individual enclosure 232 may correspond to the dimensions of the individual storage drawer 202 that resides within the individual enclosure 232. In particular, the interior of the individual enclosure 232 may have a width that accommodates the individual storage drawer 202 plus the pair of drawer rails 214 and the pair of enclosure rails 244.

In some embodiments, the individual enclosure 232 may be mounted such that the underside of the structure 900 forms the top of the individual enclosure 232. In some embodiments, the individual enclosure 232 may comprise an enclosure top 250. The enclosure top 250 may be a rectangular panel that couples to the tops of the enclosure left side wall 236, the enclosure right side wall 238, and the enclosure rear wall 240.

The individual enclosure 232 may comprise one (1) or more enclosure mounts 252 for coupling the individual enclosure 232 to the structure 900. As a non-limiting example, the one (1) or more enclosure mounts 252 may be a pair of angle brackets that couple to the individual enclosure 232 and to the structure 900.

In some embodiments, the individual storage drawer 202 may comprise a lock 260 that may be coupled to the drawer front 212. The lock 260 may engage the individual enclosure 232 and prevent opening of the individual storage drawer 202 when the lock 260 is in a LOCKED state. The lock 260 may disengage the individual enclosure 232 and permit opening of the individual storage drawer 202 when the lock 260 is in an UNLOCKED state.

In some embodiments, the individual storage drawer 202 and the individual enclosure 232 may be ventilated to allow air to pass through the individual storage drawer 202. The individual enclosure 232 may comprise one (1) or more enclosure vent apertures 270 that are covered by one (1) or more enclosure vent screens 272. The individual storage drawer 202 may comprise one (1) or more drawer vent apertures 274 that are covered by one (1) or more drawer vent screens 276. The one (1) or more enclosure vent apertures 270 and the one (1) or more drawer vent apertures 274 may be paired such that the air may move through a wall of the individual enclosure 232 and the corresponding wall of the individual storage drawer 202 unimpeded. The one (1) or more enclosure vent apertures 270 and the one (1) or more drawer vent apertures 274 may be arranged to enable a cross-breeze. As a non-limiting example, the air may move through the individual storage drawer 202 from let-to-right using vent apertures located in both left- and right-side walls of the individual enclosure 232 and the individual storage drawer 202.

In some embodiments, the invention 100 may comprise a drawer opener. The drawer opener may be operable to open and close the individual storage drawer 202 upon reception of a wireless signal 290 from a remote control 288.

As a non-limiting example, the drawer opener may comprise a motor 280 that may be coupled to the individual enclosure 232. The motor 280 may be operable to cause rotation of a mechanism comprising a plurality of pulleys 282 and a belt 284. A drawer belt interface 286 coupled to the individual storage drawer 202 may be captive to the belt 284 such that movement of the belt 284 may result in movement of the individual storage drawer 202. Movement of the belt 284 under the influence of the motor 280 in a first direction 294 may move the individual storage drawer 202 to open. Movement of the belt 284 in a second direction 296 may move the individual storage drawer 202 to close.

In some embodiments, the individual storage drawer 202 may be accessible via a trap door 292 located in a floor of the structure 900. As a non-limiting example, the one or more storage drawers 200 and the one (1) or more drawer enclosures 230 may be installed in any size house by the manufacturer or designated size house. The manufacturer may provide a floor aperture 920 covered by the trap door 292 in the floor of the house/structure and the floor aperture 920 may be positioned over one (1) of the individual storage drawers 202. The individual storage drawer 202 may be adapted to be accessible by the user when the user opens the trap door 292 from within the house/sturcture.

In use, the one (1) or more drawer enclosures 230 are added to or built into the structure 900 and the one (1) or more storage drawers 200 are placed into the one (1) or more drawer enclosures 230. The one (1) or more storage drawers 200 may provide storage for access items which may be particularly beneficial if the structure 900 is a residence with limited storage areas. The one (1) or more drawer enclosures 230 are placed on the underside of the structure 900 and the one (1) or more storage drawers 200 are inserted into the one (1) or more drawer enclosures 230. The one (1) or more drawer enclosures 230 and the one (1) or more storage drawers 200 are oriented such that the one (1) or more storage drawers 200 may be pulled out from under the structure 900 to provide access to the contents of the one (1) or more storage drawers 200. The one (1) or more storage drawers 200 may be oversized. As non-limiting examples, the one (1) or more storage drawers 200 may be large enough to hold a bicycle, lawn equipment, chairs, camping gear or other desired objects. The one (1) or more storage drawers 200 may be locked to prevent unauthorized access. In some embodiments, a drawer opener may be operable to open and close one (1) or more of the one (1) or more storage drawers 200 when activated using a remote control 288.

The exact specifications, materials used, and method of use of the invention 100 may vary upon manufacturing. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. An under-structure storage device for providing additional storage under a structure, the device comprising:
one or more storage drawers, each of the drawers having a drawer bottom, a drawer left side wall, a drawer right side wall, a drawer rear wall and a drawer front; and
one or more drawer enclosures, the enclosures being configured to receive one or more of the storage drawers, wherein the drawers having contents, wherein the contents being protected from one or more of: damage, access, contamination, and theft.

2. The device according to claim 1, wherein the one or more enclosures being coupled to an underside of a structure.

3. The device according to claim 2, wherein the structure is a crawl space under the structure.

4. The device according to claim 2, wherein the structure being a house.

5. The device according to claim 1, wherein the storage drawers being sized larger than a traditional drawer.

6. The device according to claim 5, wherein the traditional drawer being a desk drawer.

7. The device according to claim 5, wherein one of the one or more storage drawers being of a size to store a bicycle, and or desired items.

8. The device according to claim 1, wherein each of the storage drawers has a rectangular prism shape.

9. The device according to claim 1, wherein each of the storage drawers having an aperture, wherein the aperture configured to allow access to the contents.

10. The device according to claim 1, wherein each of the enclosures has an aperture for access to the storage drawers.

11. The device according to claim 1, wherein the drawer front being extended beyond a size of the aperture of the enclosures.

12. The device according to claim 1, wherein the drawer front of each of the storage drawers having a plurality of inside edges.

13. The device according to claim 12, wherein each of the storage drawers has a gasket, the gasket being coupled to the inside edges of the drawer front, wherein the gasket being pressed between the drawer front and one of the individual enclosures, wherein the gasket seals the storage drawer and the enclosure from moisture and dirt.

14. The device according to claim 1, wherein each of the storage drawers being made of a metal material.

15. The device according to claim 1, wherein each of the storage drawer has a pair of drawer rails, the drawer rails being coupled to an outside of the drawer left side wall and the drawer right side wall.

16. The device according to claim 1, wherein each of the storage drawers has a handle, wherein the handle is recessed into the drawer front.

17. The device according to claim 1, wherein each of the enclosures has an enclosure bottom, an enclosure left-side wall, an enclosure right-side wall and an enclosure rear wall.

18. The device according to claim 17, wherein each of the enclosures has a pair of enclosure rails, wherein each of the rails coupled an inside of the enclosure left-side wall and the enclosure right-side wall.

19. The device according to claim 1, wherein each of the enclosures has a rectangular prism shape.

20. The device according to claim 1, wherein each of the enclosures having an enclosure front aperture, such that each of storage drawers is moveable into and out of the enclosure.
